(19) United States
(12) Patent Application Publication
(10) Pub. No.: US 2008/0121104 A1
(43) Pub. Date: May 29, 2008

(54) Silicone antifoam composition and method using same

(76) Inventor: David George Quinn, Prangins (CH)

Correspondence Address: DILWORTH & BARRESE, LLP, 333 EARLE OVINGTON BLVD., SUITE 702, UNIONDALE, NY, 11553, US

(21) Appl. No.: 11/605,032

(22) Filed: Nov. 27, 2006

(51) Int. Cl. B01D 53/14

(52) U.S. Cl. 95/135; 516/118; 516/120; 516/124; 95/139; 95/143; 95/148

(57) ABSTRACT

There is provided herein a composition which comprises a silicone copolymer and/or terpolymer component containing a polyether moeity (a); and, a water-soluble and/or water dispersible gas-processing component (b); said composition being substantially free of metal oxide-filled non-polyether moiety-containing silicone fluid. There is also provided herein a method for processing a gas comprising treating the gas with said composition.

### BACKGROUND OF THE INVENTION

1) Field of the Invention

The invention relates to a silicone antifoam composition of particular use in processing gas(es).

2) Brief Description of the Related Art

In gas-treating processes such as the non-limiting example of the gas sweetening process, a gas (e.g., natural gas), is purified of base-reactive impurities, such as carbon dioxide and hydrogen sulfide, typically by treatment with one or more suitably reactive amine compounds. The amine forms an adduct with the base-reactive impurity, thereby removing the impurity from the gas.

There has been much focus on anti-foaming technologies in the areas of detergents, polymer processing, well treating, and waste streams. These antifoaming technologies are generally not well suited for the reduction of foam in gas treating processes.

It is known in the art to include an antifoam composition for the suppression of foam in gas treating operations. For example, an antifoaming formulation containing a silicone antifoam component, emulsifier, and water, is commercially available for this purpose under the trade name Sag®7133 (see “OSi Antifoams in the Alkanolamine Process of Gas Scrubbing,” EU-36-018/KS/fk/January, ©2001 Crompton Corporation; and “SAG®7133 and SAG®220,” GE-Advanced Materials, © 2003-2006 General Electric Company).

However, there still remains a need for gas treating compositions with more effective foam controlling properties.

### BRIEF DESCRIPTION OF THE INVENTION

The present inventors have unexpectedly discovered a low-fouling silicone antifoam composition and a method of using the same in gas processing. It has been surprisingly discovered that the silicone co and terpolymers used herein and the resultant composition(s) can exhibit water solubility (and/or dispersibility) and have a lower fouling than currently available antifoam compositions.

In one embodiment herein there is provided a composition which comprises:

(a) a silicone copolymer and/or terpolymer component containing a polyether moeity; and,

(b) a water-soluble and/or water dispersible gas-processing component; said composition being substantially free of metal oxide-filled non-polyether moiety-containing silicone fluid.

In another embodiment herein there is provided a method for processing a gas comprising treating the gas with a composition which comprises:

(a) a silicone copolymer and/or terpolymer component containing a polyether moeity; and,

(b) a water-soluble and/or water dispersible gas-processing component; said composition being substantially free of metal oxide-filled non-polyether moiety-containing silicone fluid.

The present invention advantageously provides gas-processing formulations having improved lower-fouling tendency in gas treating (such as the non-limiting example of gas sweetening) and related processes while maintaining antifoam activity for an extended period of time. Additionally, the compositions are cost-effective and readily dispersible in aqueous solutions.

### BRIEF DESCRIPTION OF THE DRAWINGS

TABLE. 1. compares the foam controlling ability (by measuring foam volume) of various silicone copolymers, described herein, in a modified foaming aqueous solution of N-methyldiethanolamine (MDEA). An aMDEA® solution available from BASF was used herein in all embodiments of this disclosure and was modified prior to use to provide the modified aqueous MDEA solution by dosing the aMDEA® from BASF with 0.1 weight percent of sodium dodecyl sulphate, said weight percent being based on the total combined weight of aMDEA® and sodium dodecyl sulphate. The various silicone copolymers and terpolymers, described herein were dosed at 17 ppm at room temperature in said modified aqueous MDEA solution and are compared in Table 1 against no antifoam in an equivalent modified aqueous MDEA solution.

TABLE. 2 compares the foam controlling ability (by measuring foam volume) of various silicone copolymers and terpolymers, described herein, in a modified foaming aqueous solution of MDEA (with the presence of certain additional solvents, as described herein, for certain copolymer and terpolymers), at a dosing of 17 ppm at 50 degrees Celsius; and compares these compositions containing the 17 ppm of the various silicone copolymers and terpolymers in an equivalent modified aqueous MDEA solution, against; no antifoam in an equivalent modified aqueous MDEA solution; dipropylene glycol in an equivalent modified aqueous MDEA solution; 2-ethylhexanol in an equivalent modified aqueous MDEA solution; and, a silica-filled polydimethylsiloxane antifoam emulsion in an equivalent modified aqueous MDEA solution.

TABLE. 3 compares the foam controlling ability (by measuring foam volume) of various silicone copolymers, described herein, in a foaming aqueous solution of MDEA, at a dosing of 17 ppm at room temperature; and compares these compositions containing the 17 ppm of the various silicone copolymers in modified aqueous MDEA solution, against; no antifoam in an equivalent modified aqueous MDEA solution at room temperature; and, a silica-filled polydimethylsiloxane antifoam emulsion in an equivalent modified aqueous MDEA solution at room temperature.

TABLE. 4 compares the foam controlling ability (by measuring foam volume) of a silicone copolymer, as described herein, in a foaming modified aqueous solution of MDEA, at a dosing of 17 ppm at room temperature; and compares this composition containing the 17 ppm of the silicone copolymer in MDEA, against; no antifoam in an equivalent modified aqueous MDEA solution; polypropylene glycol in an equivalent modified aqueous MDEA solution; the same silicone copolymer with 3 weight percent of fumed silica powder in an equivalent modified aqueous MDEA solution; the same silicone copolymer with 3 weight percent of precipitated silica powder in an equivalent modified aqueous MDEA solution; a 50:50 weight percent blend, of a combination of the same silicone copolymer with 3 weight percent of fumed silica powder, and polypropylene glycol, in an equivalent modified aqueous MDEA solution; a 50:50 blend, of a combination of the same silicone copolymer with 3 weight percent of precipitated silica powder, and polypropylene glycol, in an equivalent modified aqueous MDEA solution; and, a 50:50 blend of the same silicone copolymer, and polypropylene glycol, in an equivalent modified aqueous MDEA solution wherein said 50:50 weight percent is understood to be 50 weight percent of the silicone copolymer and any silica and 50 weight percent of polyproylene glycol, and further wherein 3 weight percent silica in said 50:50 blends is 3 weight percent based on the combined weight of the copolymer and silica. It will be understood herein that when polypropylene glycol is used herein, that it is simply physically blended with the silicone copolymer and/or terpolymer and any metal-oxide that may be present in the silicone copolymer (such as the non-limiting example of metal oxide-filled silicone fluid, such as the non-limiting example of silica-filled polydimethylsiloxane) prior to use.

Table 5 compares the antifoam activity, as measured in milliliters of foam volume, over a fixed period of time, for various silicone copolymers and terpolymers against the absence of antifoam, at periods of 1 day, 1 week and 2 weeks.

### DETAILED DESCRIPTION OF THE INVENTION

The composition of the invention, (specifically a low-fouling silicone antifoam composition) includes, a silicone copolymer and/or terpolymer component that contains at least one polyether moiety (i.e., component (a)) and a water-soluble and/or water-dispersible gas processing component (i.e., component (b)), said composition being substantially free of metal oxide-filled non-polyether moiety-containing silicone fluid. It will be understood herein that the composition described herein has an anti-foaming and/or defoaming effect in a process of treating a gas, (e.g. gas sweetening) as well as providing a lower level of fouling when used in the treatment of gas as compared to the use of an antifoam prepared composed of a metal oxide-filled non-polyether moiety-containing silicone fluid.

It will also be understood herein that all weight percents are based upon total weight percent of the composition herein, unless stated otherwise.

It will also be further understood herein that all molecular weight herein are theoretically calculated based upon their nominal structure unless stated otherwise. The nominal structure is based upon charges of M¹ₐ, M²_{b}, M³_{c}, D²ₑ, D³_{f} T¹_{g}, T²ₕ, T³ⱼ, and Qⱼ, as shown below in formula (1).

It will also yet even further be understood herein that that all ranges stated herein comprise all subranges there between, and can further comprise any combination of ranges and/or subranges.

In one embodiment herein, the silicone copolymer and/or terpolymer component (a) contains at least one polyether moiety, specifically ethylene oxide (EO), propylene oxide (PO) and butylene oxide (BO) moieties. Specifically such EO and PO moieties exist in a weight ratio of EO to PO of specifically from about 0:1 to about 1:0, more specifically of from about 1:1 to about 1:6 and most specifically of from about 1:2 to about 1:4 in the silicone copolymer and/or terpolymer component (a). In another embodiment herein silicone copolymer and/or terpolymer component (a) has a molecular weight of from about 2,000 to about 100,000, more specifically of from about 5,000 to about 75,000, and most specifically of from about 10,000 to about 50,000. In yet one other embodiment herein, the silicone copolymer and/or terpolymer component (a) can be at least one pendant and/or linear structure. In one embodiment herein it will be understood that silicone copolymer and/or terpolymer component (a) having a linear structure is a silicone polyether copolymer and/or terpolymer that has at most two polyether moieties attached to each silicone moiety. This attachment is usually accomplished by attaching the polyether moieties to the terminal groups of a linear (not branched) silicone polymer. In one embodiment herein, any linear silicone copolymers and/or terpolymers described herein can be in one specific embodiment, ABA or (AB)ₓ (such as the non-limiting example of (AB)ₓA copolymers described herein) polymers wherein x is at least 1. Although, in specific cases with purification (distillation) of low molecular silicones it may be possible to have silicone polymers and/or terpolymers with at most two reactive groups that are located between the terminal groups, in a linear fashion. But generally the introduction of reactive groups between the terminal groups results in a distribution of silicone copolymers and/or terpolymers, some of which have more than two reactive groups for each silicone moiety, which can provide for addition of the polyether moieties thereon. This type of silicone will generate pendant silicone polyether copolymers and/or terpolymers. Hence in general, a pendant silicone polyether copolymer and/or terpolymer is one where the polyether moieties are attached at points between the terminal silicone groups. In one specific embodiment, the silicone pendant copolymer and/or terpolymer component (a) has a molecular weight as described above and contains an ethylene oxide to propylene oxide weight ratio as described above. In one embodiment herein silicone pendant copolymer and/or terpolymer component (a) can be those of a high molecular weight, specifically greater than about 2,000, more specifically greater than about 5,000 and most specifically greater than about 10,000 number average molecular weight. In one embodiment, the silicone copolymer and/or terpolymer component (a) can be those of a molecular weight of greater than or equal to 2,500 Daltons. In a further embodiment, herein silicone terpolymer can have the same and/or different molecular weights as described herein for silicone copolymer. In one embodiment herein silicone copolymer and/or terpolymer component (a) has a molecular weight of from about 1,500 to about 100,000. In another embodiment herein, silicone pendant copolymer and/or terpolymer component (a) has a molecular weight of from about 7,000 to about 50,000 and contains an ethylene oxide to propylene oxide weight ratio of from about 1:4 to about 4:4.

In another embodiment herein the silicone copolymer and/or terpolymer component (a) can be wherein the silicone copolymer and/or terpolymer component (a) is at least one hydrolyzable (Si—O—C moiety-containing) and/or non-hydrolyzable (Si—C moiety-containing) silicone copolymer and/or terpolymer.

In another embodiment, the copolymers and/or terpolymers of component (a) are those having one or more polyorganosiloxane portions (such as the non-limiting example of polydimethylsiloxane) and one or more hydrophilic or hydrophobic portions (such as at least one polyether moiety), of which a particularly specific subclass is the polydimethylsiloxane-polyoxyalkylene copolymers (PDMS-polyoxyalkylene copolymers).

Particularly preferred members of component (a) are PDMS-polyoxyalkylene copolymers wherein the polyoxyalkylene portion is composed of at least one oxyethylene unit, oxypropylene unit, or oxybutylene unit. Such copolymers are well known in the art and are commercially available under the Silwet® trade name. These commercially available PDMS-polyoxyalkylene copolymers are described in detail in U.S. Pat. No. 3,505,377 to Morehouse and U.S. Pat. No. 6,051,533 to Kajikawa et al., both of which are incorporated by reference herein in their entirety.

The PDMS-polyoxyalkylene polymers can be of any arrangement of PDMS and polyoxyalkyene units, but are preferably either linear or pendant copolymers (see formulas I and II in U.S. Pat. No. 6,051,533 to Kajikawa et al.) as described herein. Combinations of linear and pendant copolymers are also contemplated.

In a particularly specific embodiment, the component (a) includes one or more, polyorganosiloxane-polyalkylene co- or ter-polymers within the formula (1):

M¹ₐM²_{b}M³_{c}D¹_{d}D²ₑD³_{f}T¹_{g}T²ₕT³ᵢQⱼ; (1)

where

M¹ₐ=R¹R²R³SiO_{1/2};

M²_{b}=R⁴R⁵R⁶SiO_{1/2};

M³_{c}=R⁷R¹R⁹SiO_{1/2};

D¹_{d}=R¹⁰R¹¹SiO_{2/2};

D²ₑ=R¹²R¹³SiO_{2/2};

D³_{f}=R¹⁴R¹⁵SiO_{2/2}

T¹_{g}=R¹⁶SiO_{3/2};

T²ₕ=R¹⁷SiO_{3/2};

T³ᵢ=R¹⁸SiO_{3/2}; and,

Qⱼ=SiO_{4/2};

where R¹, R², R³, R⁵, R⁶, R⁸, R⁹, R¹⁰, R¹¹, R¹³, R¹⁵ and R¹⁶ are each independently selected from the group consisting of one to twenty carbon monovalent hydrocarbon radicals, an alkoxy radical OR¹⁹ (where R¹⁹ is independently selected from the group consisting of one to six carbon monovalent hydrocarbon radicals) and an hydroxy (OH) radical;
where R⁴, R¹² and R¹⁷ are independently selected from a polyether moiety; where, R⁷, R¹⁴ and R¹⁸ are independently selected from an alkyl or aryl group containing at least one of an alcohol, ether or an epoxy group; and,
where the subscripts a, b, c, d, e, f, g, h, i, and j are zero or positive integers with the provisos that (in one specific embodiment of formula (1), any one or more of a, b, c, d, e, f, g, h, i, and j can each independently be at least 1 provided there is at least two of any of M¹, M², or M³ units and at least two of any of D¹, D², or D³ units in formula (1)):
(a+b+c)=(2+g+h+i+2j)
2≦(d+e+f);
0≦(g+h+i)≦5;
0≦j≦3
and with the further proviso that 1≦b+e+h≦50;
and 0≦c+f+i≦50.

In a further more specific embodiment of formula (1):

R², R³, R⁵, R⁶, R⁸, R⁹, R¹⁰, R¹¹, R¹³, R¹⁵ and R¹⁶ are specifically, each independently selected from the group consisting of one to six carbon monovalent hydrocarbon radicals, an alkoxy radical OR¹⁹ (where R¹⁹ is independently selected from the group consisting of one to three carbon monovalent hydrocarbon radicals) and a hydroxy (OH) radical; more specifically,
each independently selected from the group consisting of methyl, ethyl or phenyl radicals; and most specifically,
are methyl radicals; and,

### R¹ is specifically,

independently selected from the group consisting of one to six carbon monovalent hydrocarbon radicals, an alkoxy radical OR¹⁹ (where R¹⁹ is independently selected from the group consisting of one to three carbon monovalent hydrocarbon radicals) and an hydroxy (OH) radical; more specifically,
independently selected from the group consisting of a methyl radical, a methoxy radical, an ethoxy radical and a hydroxy radical; and most specifically, independently selected from methyl, hydroxy or methoxy radicals.

In yet a further embodiment of formula (1) herein there is provided a silicone copolymer and/or terpolymer component (a) that has no branching, such that, g=h=i=j=0 therefore a+b+c=2.

In yet an even further embodiment of formula (1) herein there is provided a silicone copolymer and/or terpolymer component (a) that is a copolymer wherein, c=f=i=0.

In yet an even still further embodiment of formula (1) herein there is provided a silicone copolymer and/or terpolymer component (a) that is a linear ABA copolymer wherein a=c=e=f=g=h=i=j=0, therefore b=2.

In yet another further embodiment of formula (1) herein there is provided a silicone copolymer and/or terpolymer component (a) that is a pendant structure wherein, b=c=g=h=i=j=0.

In yet another even further embodiment of formula (1) herein there is provided a silicone copolymer and/or terpolymer component (a) that is a pendant copolymer wherein, b=c=f=g=h=i=j=0.

In one still further embodiment of formula (1) herein there is provided a silicone copolymer and/or terpolymer component (a) that is wherein specifically

0≦(d+e+f), more specifically,

5≦(d+e+f)<500, and most specifically,

10≦(d+e+f)<400.

In one still yet even further embodiment of formula (1) herein (except for the above stated linear ABA copolymers) there is provided a silicone copolymer and/or terpolymer component (a) that is wherein specifically

1≦b+e+h≦50, more specifically,

1≦b+e+h≦25, and most specifically,

1≦b+e+h≦15.

In one still further embodiment of formula (1) herein (except for the above stated linear ABA copolymers) there is provided a silicone copolymer and/or terpolymer component (a) that is wherein specifically,

0≦c+f+i≦50, more specifically

0≦c+f+i≦25 and most specifically,

0≦c+f+i≦15.

In any embodiment of formula (1) herein, R⁴, R¹² and R¹⁷ can each independently be (CH₂)ₙ—(OCH₂CH₂)ₘ—(OCH₂CHCH₃)ₚ-Z,

where the subscripts n, m and p are zero or positive integers, and more specifically, 1≦n≦6 and 2≦(m+p)≦100;

### Z represents a capping group specifically selected from —OCH₃, —OCH₂CH₃, —(OCOCH₃) or —OH, and more specifically, Z represents a methoxy or hydroxy group; and most specifically Z represents a methoxy group.

In any embodiment of formula (1) herein, R⁷, R¹⁴ and R¹⁸ can independently be selected from linear, branched or cyclic hydrocarbon groups (wherein said hydrocarbon groups are saturated or unsaturated) containing up to about 30 carbon atoms, more specifically up to about 20 carbon atoms, even more specifically up to about 16 carbon atoms, and most specifically up to about 12 carbon atoms, wherein specifically said linear, branched or cyclic hydrocarbon groups can be branched with, or can contain in the backbone of said hydrocarbon group, at least one of an alkanol group, an ether group, or an epoxy group, some non-limiting specific examples of R⁷, R¹⁴ and R¹⁸ are C₃H₆—CH₂—C(CH₂OH)₂—C₂H₅, C₃H₆—O—CH₂CHOHCH₂OH and C₃H₆—C₆H₄(OCH₃)OH. In one specific embodiment herein linear, branched or cyclic hydrocarbon groups can comprise alkyl, aryl, alkenyl alkynyl, acyl, aromatic, ether, ester, substituted and unsubstituted amine, or amide groups.

In a further embodiment of silicone copolymer and/or terpolymer component (a) can be an (AB)xA copolymer wherein part A represents a polyether moiety and part B represents a silicone moiety and x is the number of repeating units and wherein x can be at least one, more specifically from 1 to about 50, even more specifically 1 to about 30, and most specifically 1 to about 20.

In a more specific embodiment the silicone moiety (B) of an (AB)xA silicone copolymer and/or terpolymer can be described with the following formula:

D¹_{d}D²ₑD³_{f}T¹_{g}T²ₕT³ᵢQⱼ; (2)

wherein D¹, D², D³, T¹, T², T³, and Q are as defined above; and, the polyether moiety (A) of an (AB)xA silicone copolymer and/or terpolymer can be described with the following formula:

—(OCH₂CH₂)ₘ—(OCH₂CHCH₃)ₚ—O— (3)

where m and p are as defined above; and, where the silicone portion is linked to a polyether portion via a divalent organic bridge (L) wherein L can optionally contain at least one heterogenous group, and the polyether moeity (A) that is only attached to one silicone moiety (B), has a monovalent organic terminal group (T) on the other end of the polyether moiety, wherein T can optionally contain at least one heterogenous group therein and wherein R¹⁰, R¹¹, R¹³, R¹⁵ and R¹⁶ are as defined above;

### R¹² and R¹⁷ are as defined above; and

where, R¹⁴ and R¹⁸ are as defined above; and,
where the subscripts d, e, f, g, h, i, and j are as defined above, with the provisos that (in one specific embodiment of formula (2), any one or more of d, e, f, g, h, i, and j can each independently be at least 1 provided there is at least two of any of D¹, D², or D³ units in formula (2))

2≦(d+e+f);

0≦(g+h+i)≦5;

0≦j≦3

and with the further proviso that 0≦e+h≦50;

and 0≦f+i≦50.

In one specific embodiment herein, the divalent organic bridge (L) that links the polyether moiety (A) to the silicone moiety (B) is a divalent hydrocarbon unit. This linking group (L) can be an saturated or unsaturated divalent alkyl, alkene or alkyne unit that can optionally include at least one additional functionality such as, but not limited to, an ether, amine, quaternatised nitrogen group, ester, or ketone. Some non-limiting specific examples of L are:

—CH₂— (CH₂)ᵤ—CH₂—

—(CH₂)ᵤ—O—CH₂—CH(OH)—CH₂—NH—(CH₂)ᵤ—

where each u is independently selected from a value of 1≦u≦12.

In another specific embodiment, the monovalent organic terminal group (T) that is attached to a polyether moiety (A) is a monovalent hydrocarbon unit. This terminal group can be a saturated or unsaturated divalent alkyl, alkene or alkyne unit that can optionally include at least one functionality such as, but not limited to, an ether, amine, quaternatised nitrogen group, ester, or ketone. Some non-limiting specific examples of T are:

—CH₂—(CH₂)ᵤ—CH₃

—CH₂—(CH₂)ᵤ—CH═CH₂

—(CH₂)ᵤ—O—CH₂—CH(OH)—CH₂OH

—(CH₂)ᵤ—NH₂

where 0≦u≦12, specifically each u is the same or different value of from 1 to about 12.

In yet a further embodiment of formula (2) herein there is provided a silicone copolymer and/or terpolymer component (a) that has no branching, such that, g=h=i=j=0.

In yet an even further embodiment of formula (2) herein there is provided a silicone copolymer and/or terpolymer component (a) that is a copolymer wherein, f=i=0.

In yet an even further embodiment of formula (2) herein there is provided a silicone copolymer and/or terpolymer component (a) that is a linear copolymer with no pendent functionality, wherein, e=f=g=h=i=j=0, which results in the following structure:

T-(OCH₂CH₂)ₘ—(OCH₂CHCH₃)ₚ—O-(L-D¹_{d}-L-(OCH₂CH₂)ₘ—(OCH₂CHCH₃)ₚ]ₓ-OT

where L, T, D¹, d, m, p and x are as defined.

In a further embodiment the metal oxide-filled non-polyether moiety containing silicone fluid, which the composition is substantially free of, can be a metal-oxide-filled base silicone fluid that is in the absence of polyether moieties. In another specific embodiment herein, a metal oxide-filled non-polyether moiety-containing silicone fluid can comprise methyl, vinyl, or silanol end-blocked silicones, which silicones are not used in the composition(s) (specifically not used in silicone copolymer and/or terpolymer component (a)) herein. In one embodiment herein, the absence of the metal oxide-filled non-polyether moiety-containing silicone fluid; such as methyl, vinyl, silanol . . . etc end blocked silicones, in the composition(s) herein, can result in less fouling in gas processing applications compared to gas processing applications that do use such metal oxide-filled non-polyether moiety containing silicone fluids.

The values provided herein for the specific pendant polyorganosiloxane-polyoxyalkylene copolymers and/or terpolymers are averages and are not intended to represent absolute values.

In yet one more embodiment herein, specifically, the polydimethylsiloxane-polyoxyalkylene copolymer herein has a polydimethylsiloxane portion bound to a polyoxyalkylene portion selected from the group consisting of a polyoxyethylene group, polyoxypropylene group, polyoxybutylene group and combinations thereof.

In yet still another embodiment herein silicone copolymer and/or terpolymer component (a) can comprise at least one of pendant and/or linear structure, hydrolyzable and/or non-hydrolyzable silicone copolymer and/or terpolymer, and polyorganosiloxane-polyoxyalkylene copolymer and/or terpolymer as they are described herein.

In one embodiment herein silicone copolymer and/or terpolymer component (a) can be at least one of the silicone copolymers or terpolymers provided in Table A below and any others described herein that are not, or are substantially free of, metal oxide-filled non-polyether moiety-containing silicone fluid.

In one specific embodiment herein the water-soluble or water-dispersible gas-processing component (i.e., component (b)) is a gas treating agent (such as the non-limiting example of a gas sweetening agent), and more specifically, a gas sweetening amine. In one embodiment herein gas-treating agent can be any material used in the treatment and/or processing of gases, specifically any material capable of reacting with a base-reactive impurity in a gas. In a more specific embodiment the gas treating agent (such as the non-limiting example of the gas sweetening amine) includes any one or combination of amino-containing compounds or polymers capable of reacting with a base-reactive impurity in a gas while in the present composition. The amines are specifically at least partially soluble in aqueous solution. If necessary, amines of low aqueous solubility can be emulsified using one or more suitable surfactants.

Some non-limiting examples of classes of suitable gas treating agent (such as the non-limiting example of the gas sweetening amine) includes alkanolamines, alkylamines, and combinations thereof. Some particularly specific alkanolamines include the non-limiting examples of monoethanolamine, diethanolamine (DEA), diisopropanolamine, triethanolamine, N-methyldiethanolamine (MDEA), monomethylethanolamine, (2-(2-aminoethoxy)ethanol (i.e., Diglycolamine® Agent or DGA® available from Huntsman Corporation), and combinations thereof.

Some non-limiting examples of classes of suitable gas treating agent which are alkylamines (such as the non-limiting example of the gas sweetening alkylamine) include monoalkylamines, dialkylamines, trialkylamines, and combinations thereof. Some specific non-limiting examples of monoalkylamines include methylamine, ethylamine, n-propylamine, isopropyl amine, n-butylamine, isobutylamine, sec-butylamine, and t-butylamine. Some specific non-limiting examples of dialkylamines include dimethylamine, diethylamine, methylethylamine, isopropylmethylamine, isopropylethylamine, diisopropylamine, and isobutylmethylamine. Some specific non-limiting examples of trialkylamines include trimethylamine, triethylamine, tri(n-propyl)amine, ethyldimethylamine, n-propyldimethylamine, isobutyldimethylamine, and diisopropylmethylamine.

The gas-treating agent (such as the non-limiting example of gassweetening amines) can also include the polyamines, i.e., diamines, triamines, tetramines, and higher amines. Some specific non-limiting examples of such amines include ethylenediamine, diethylenetriamine, triethylenetetramine, tetraethylenepentamine, and polyamine polymers.

The gas-treating agent (such as the non-limiting example of gas sweetening amines) can also include amino-containing ring compounds. Some specific non-limiting specific examples of such compounds include the piperidines, piperazines, pyridines, pyrazines, pyrroles, pyrrolidines, pyrrolidinones, morpholines, anilines, aminophenols, anisidines, triazines, and the like.

The gas-treating agent (such as the non-limiting example of gas sweetening amines) can also include imines formed by a condensation reaction between an amine and a carbonyl-containing compound such as formaldehyde.

The gas-treating agent (such as the non-limiting example of gassweetening amines) can be non-selective, and hence, reactive to any number of base-reactive impurities in a gas. Alternatively, the gas-treating agent (such as the non-limiting example of gas sweetening amines) can be selective, i.e., more reactive to one or a particular group of base-reactive impurities, or perhaps unreactive to one or more base-reactive impurities while reactive to one or more other base-reactive impurities.

The composition described herein, is as indicated above, substantially free of metal oxide-filled non-polyether moiety-containing silicone fluid. The metal oxide-filled non-polyether moiety containing silicone fluid (which is substantially absent in the present composition) is any of the commercially available metal oxide-filled non-polyether moiety containing polyorganosiloxane fluids used as defoamers in gas treatment and/or processing applications such as the non-limiting example of gas sweetening, such as the non-limiting examples of SAG®7133 available from GE Advanced Materials. The term “filled” as used herein indicates the presence of a substantial amount of metal oxide dispersed and/or mixed in, silicone copolymer and/or terpolymer component (a) or, in non-polyether moiety containing metal oxide-filled silicone fluid, that is specifically from about 0.1 to about 40, more specifically form about 0.5 to about 20 and most specifically from about 1 to about 10 weight percent of metal oxide based on the total weight percent of the silicone copolymer and/or terpolymer component (a) or the metal oxide-filled non-polyether moiety-containing silicone fluid, as the term “filled” is used herein to refer to either a metal oxide-filled silicone copolymer and/or terpolymer component (a) or, the composition(s) herein being in the substantial absence of non-polyether moiety containing metal oxide-filled silicone fluid. In one specific embodiment herein silicone copolymer and/or terpolymer component (a) can comprise a base silicone fluid (that is a silicone copolymer and/or terpolymer containing at least one polyether moiety) that is filled with metal oxide, and specifically the base silicone fluid of metal oxide-filled silicone copolymer and/or terpolymer component (a) is a silicone fluid (that is a silicone copolymer and/or terpolymer containing at least one polyether moiety) and the metal oxide is particulate silica. Particulate silica herein is selected from the group consisting of fumed silica, precipitated silica and combinations thereof. In one embodiment herein the most specific silica used herein can be prehydrophobised silica. In another embodiment herein, the silicone copolymer and/or terpolymer component (a) that is filled with metal oxide also optionally contains polypropylene glycol as described herein. In one embodiment herein the silicone fluid as defined herein can be a polyorganosiloxane that contains a polyether moiety, specifically a polydimethylsiloxane that contains a polyether moiety.

The metal oxide as used herein can be any of the suitable metal oxides known in the art. Some examples of suitable metal oxides include filmed, precipitated, or plasmatic forms of titania, alumina, silica, alumina-silica, zironia, zirconia-silica, and any combinations thereof. Most specific for the metal oxide is silica.

The composition herein can also optionally include one or more catalysts capable of promoting condensation reactions between siloxy groups. Some non-limiting examples of such catalysts include alkali metal hydroxides (e.g., potassium hydroxide, sodium hydroxide, and cesium hydroxide), alkali metal silanolates (e.g., potassium silanolate), alkali metal alkoxides (e.g., potassium ethoxide), quaternary ammonium hydroxides (e.g., betahydroxyethyltrimethyl ammonium hydroxide, benzyltrimethyl ammonium hydroxide, tetramethyl ammonium hydroxide), quaternary ammonium silanolates, quaternary phosphonium hydroxides, and metal salts of organic acids (e.g., dibutyltin laurate, stannous acetate, stannous octanoate, and the like).

In another embodiment herein, the composition herein also can further comprise a polypropylene glycol component. In one embodiment herein, the combination of polypropylene glycol in the composition described herein results in formulations with more effective antifoaming ability as compared to polypropylene glycol alone (wherein polypropylene glycol alone would be outside the scope of this disclosure).

It will be understood herein that when polypropylene glycol is used herein, that it is simply physically blended with the silicone copolymer and/or terpolymer component (a) and any metal-oxide that may be present in the silicone copolymer and/or terpolymer component (a) prior to use.

The phrase “water soluble and/or water dispersible” as it relates to component (b) herein, is defined as including solubility, dispersibility, or emulsifiability at room temperature (circa 25° C.), as well as under elevated temperature conditions (warming or heating conditions, such as for example at least about 30 degrees Celsius.) In another more specific embodiment herein “water soluble and/or water dispersible”, as it relates to component (b) herein, is defined as the at least 5 weight percent solubility of the gas processing component (b) in the composition, more specifically at least 25 weight percent and most specifically at least about 50 weight-percent wherein said weight percents are based on the total amount of gas processing component (b) used in the composition(s) herein.

The term “polypropylene glycol” herein also includes all of the polymers under the term “polypropylene oxide,” as well as any of the water-soluble co-polymers having polypropylene glycol portions and one or more other portions. For example, the polypropylene glycol can be a copolymer of polypropylene glycol and ethylene glycol. The copolymers can be in any arrangement, e.g., block, random, alternating, graft, or combinations thereof. The polypropylene glycol can also include additional functionality, e.g., polypropylene glycol bis-(2-aminopropyl ether) and polypropylene glycol monobutyl ether.

The polypropylene glycol can also be linear or branched, as well as atactic or isotactic. An example of a branched polypropylene glycol is the product of copolymerizaton between propylene oxide and a triol, such as glycerol, i.e., poly(propylene glycol)triol (otherwise known as glycerol propoxylate).

Some examples of suitable polypropylene glycols include those with number average molecular weights (Mₙ) of about 50 to about 5,000, viscosities of about 10 to about 2,000 centistokes, and hydroxyl numbers of about 10 mg KOH/g to about 400 mg KOH/g. For example, the polypropylene glycol can have an Mₙ of about 425, a viscosity of 80 centistokes, and a hydroxyl number of about 263 mg KOH/g; or an Mₙ of about 725, a viscosity of 115 centistokes, and a hydroxyl number of about 147 mg KOH/g; or an Mₙ of about 1,000, a viscosity of 150 centistokes, and a hydroxyl number of about 111 mg KOH/g; or an Mₙ of about 2,000, a viscosity of 300 centistokes, and a hydroxyl number of about 56 mg KOH/g; or an Mₙ of about 2,700, a viscosity of 630 centistokes, and a hydroxyl number of about 37 mg KOH/g; or an Mₙ of about 3,500, a viscosity of 1,300 centistokes, and a hydroxyl number of about 28 mg KOH/g; or any combination of any of the polypropylene glycols described above.

The polypropylene glycol component and component (a) can be in any suitable weight ratio of polypropylene glycol to component (a). In one embodiment, for example, the polypropylene glycol to component (a) weight ratio is specifically in the approximate range of 1:20 to 100:1 or 1:20 to 200:1. In a different embodiment, for example, the polypropylene glycol to component (a) weight ratio can be preferably about 1:20, 1:10, 1:5, 1:4, 1:3, 1:2, 1:1, 2:1,3:1,4:1,5:1, 10:1, 20:1, 30:1, 40:1, 50:1, 100:1 or 200:1.

More specifically herein, the polypropylene glycol to component (a) weight ratio is in the approximate range of about 2:1 to 100:1, specifically 2:1 to 50:1, more specifically 2:1 to 20:1, and even more specifically 2:1 to 10:1. In other embodiments, the polypropylene glycol to component (a) weight ratio is specifically in the approximate range of about 1:10 to 10:1, or a subrange therebetween, e.g., 1:1 to 10:1, 1:10 to 1:1, 1:5 to 5:1, 1:1 to 5:1, or 1:5 to 1:1.

In one other embodiment herein the composition herein also further comprises water. The water component can be purely water or substantially water along with an amount of one or more hydrophilic solvents. For example, the water component can include one or more alcohols, cyclic ethers, or ketones. The water component is typically the highest amount by weight of the composition (e.g., at least 50, 60, 70, 80, or 90 percent by weight).

In one embodiment herein the composition described herein is specifically a gas-processing composition, more specifically a gas-processing antifoam composition, most specifically a low-fouling gas processing antifoam composition. In one more specific embodiment the composition herein can contain component (a) in an amount of from about 1 to about 5,000 ppm, more specifically of from about 5 to about 4,000 ppm and most specifically of from about 10 to about 2,000 ppm based on the total weight of the composition. In another embodiment herein the composition herein can contain component (b) in the respective remaining amounts of the composition, when component (a) is used in the amounts indicated above, and optionally, if used, any polypropylene glycol, and/or any metal oxide, and/or water that is used in the amounts indicated herein. In yet another embodiment herein the composition herein can contain polypropylene glycol in an amount of from about 1 to about 5000 ppm, more specifically of from about 5 to about 4000 ppm and most specifically of from about 10 to about 2000 ppm based on the total weight of the composition. In yet even another embodiment herein the composition herein can contain water in an amount of from about 30 to about 95 weight percent, more specifically of from about 40 to about 95 weight percent and most specifically of from about 50 to about 95 weight percent based on the total weight of the composition. In another embodiment herein, the composition can contain any of the above-described components (a) and (b), and optionally, polypropylene glycol and water, all in the above-described amounts. The amount of metal oxide that can be used in the composition(s) herein can vary greatly depending on the particular application which the composition is used treat and the specific on-site conditions. In one specific non-limiting embodiment herein the composition can contain specifically of from about 0.1 to about 500 ppm of metal oxide based on the total weight of the composition. In yet a further embodiment, the composition herein can contain specifically of from about 0.1 to about 30, more specifically of from about 0.5 to about 20 and most specifically of from about 1 to about 10 weight percent metal oxide wherein said weight percent is based on the total weight of component (a).

In the embodiments herein, the composition(s) herein described as being substantially free of metal oxide-filled non-polyether moiety-containing silicone fluid may comprise specifically for example specifically less than about 0.5 weight percent, more specifically less than about 0.1 weight percent, and most specifically less than about 0.01 weight percent of metal oxide-filled non-polyether moiety-containing silicone fluid said weight percent being based on the total amount of silicone in the composition. In one embodiment herein the composition can comprise silicone copolymer and/or terpolymer component (a) that can be filled with metal oxide and can be present alone or in combination with another silicone copolymer and/or terpolymer component (a) as described herein. In one embodiment herein the composition described herein will have a lower level of fouling in gas processing equipment as compared to an equivalent amount of a metal oxide-filled non-polyether moiety-containing silicone fluid antifoam composition (such as those commercially available), specifically about 25 percent less fouling, more specifically about 35 percent less fouling and most specifically about 50 percent less fouling, said percent being based on the total amount of fouling when using a metal oxide-filled non-polyether moiety-containing silicone fluid antifoam composition. In one non-limiting embodiment herein the composition(s) herein can be in the form of dispersions of silicone copolymer and/or terpolymer component (a) in gas processing component (b). Dispersions can be prepared in methods that are known to those skilled in the art. In another embodiment herein the composition(s) herein can result in specifically a 5 percent reduction in foaming, more specifically a 10 percent reduction in foaming, and most specifically a 20 percent reduction in foaming in a gas processing composition; which contains at least one base-reactive impurity, and other possible contents as is known to those skilled in the art, and is exposed to conditions which are known to those skilled in the art to cause foaming; such as the non-limiting example of gas-sweetening composition, wherein said gas-processing composition(s) is used in gas-processing applications, and when compared to a gas-processing composition that does not contain an antifoam composition. In one other embodiment, the composition(s) described herein can likewise be used in processes and applications of glycol dehydration.

In another specific embodiment herein, the above-described method for processing a gas can comprise lowering or substantially removing an amount of at least one base-reactive impurity from a gas by treating the gas with any one or more of the compositions described above. The method advantageously processes the gas (removes base-reactive impurities) while effectively removing and/or suppressing the formation of foam in the method.

The gas to be processed can be any of the commonly known gases, which require removal of base reactive species. In a more specific embodiment, the gas is at least substantially composed of methane, i.e., natural gas. The gas can also be any other hydrocarbon gas including the non-limiting examples of ethane, propane, butane, and the like, as well as inert gases, such as the non-limiting examples of nitrogen and the noble gases.

The base-reactive impurities in the gas are most commonly the non-limiting examples of carbon dioxide, sulfhydryl-containing compounds, and combinations thereof. The sulfhydryl-containing compounds include, most notably, the non-limiting examples of hydrogen sulfide, but can include other mercaptans such as methanethiol.

In the method herein, the gas can be treated by any means known in the art for gas sweetening or gas dehydration. For example, the gas can be treated by spraying or aerosoling the compositions described above in the gas, or bubbling the gas through the gas processing composition, or any combination of said spraying, aerosoling or bubbling. See, for example, “Oilfield Processing of Petroleum: Natural Gas (Oilfield Processing of Petroleum)” by Francis S. Manning, © 1991, PennWell Publishing Co., Tulsa, Okla., which is herein incorporated by reference in its entirety.

In a more specific embodiment, the gas processing component, e.g., gas sweetening amine, is reclaimed by a gas desorption process. The term reclaimed refers to a process, wherein about 10% of the solution of the composition herein and any base reactive impurities passes through the desorber where the acid gases are removed and part of the gas processing component (such as the non-limitinge example of alkanolamine) can be recaptured for further adsorption. In the gas desorption process, elevated temperature and/or reduced pressure is used to effect the desorption of the adducted base-reactive species, thereby reclaiming at least a portion, and more specifically at least a substantial portion, of the gas processing component. In one embodiment herein gas-processing component (b) is present in the composition in a gas-processing effective amount. A gas-processing effective amount is an amount of gas processing component (b) that can cause at least some sweetening of a gas that is being removed in a gas-sweetening process. In a more specific embodiment herein a gas-processing effective amount is an amount that will cause at least about a 1 percent reduction in the amount of base-reactive impurities in the gas, more specifically, a 10 percent reduction in the amount of base-reactive impurities in the gas, even more specifically, a 25 percent reduction in the amount of base-reactive impurities in the gas and most specifically a 50 percent reduction in the amount of base-reactive impurities in the gas, said percents being based on the total amount of base-reactive impurities in the gas being treated, said percent reductions also defining the “substantial” removal of a base-reactive impurity in the gas.

In a more specific embodiment, in the above-described method for processing a gas, treating the gas with the composition described herein, is accomplished by mixing an amount of the silicone copolymer and/or terpolymer component (a) described herein with an aqueous solution containing a gas processing component (b) as described herein. In an even more specific embodiment herein, an amount of the above component (a) is mixed with an aqueous amine gas sweetening solution (comprising water and component (b) and optionally polypropylene glycol and optionally metal oxide) so as to provide a mixture having the component (a) in a minimum amount of approximately 1 ppm, 5 ppm, or 10 ppm to a maximum amount of about 100 ppm, 500 ppm, 1000 ppm or 2000 ppm, and all ranges resulting from combination of the minima and maxima given, and all subranges there between, by weight of component (a) and polypropylene glycol and any metal oxide or by weight of the final mixture. The resulting mixture containing the amine is then used to treat the gas in a gas sweetening process. In one even more specific embodiment herein the amount of composition herein that can be used in a method for processing a gas can vary greatly depending on the individual gas that is to be treated but can comprise an amount that will result in the above indicated amounts of reduction in base-reactive impurities.

For gas sweetening applications, an aqueous amine solution (of water and component (b) and optionally polypropylene glycol and optionally metal oxide) comprises one or more alkanolamines, alkylamines, or combination thereof, in aqueous solution, specifically, in a minimum amine weight percentage of about 5% and a maximum amine weight percentage of about 75% by weight of the aqueous solution. Some more specific non-limiting amine concentrations include 15 to 30 weight percent of monoethanolamine, or 30 to 40 weight percent of diethanolamine, or 40 to 50 weight percent of methyldiethanolamine, or up to about 65 weight percent of 2-(2-aminoethoxy)ethanol, and combinations thereof.

It has also been surprisingly discovered herein that the composition(s) described herein can be a low-fouling antifoam composition, most specifically a low-fouling gas processing antifoam composition that retains its antifoaming ability for specifically at least a period of 1 week, more specifically at least a period of 2 weeks, and most specifically at least a period of one month. It will be understood herein that antifoaming ability is the capability of the composition to result in the percent reduction(s) of foam described above, compared to a gas processing composition in the presence of at least one base-reactive impurity, that does not contain antifoam. In yet a further embodiment herein, the use of the silicone copolymer and/or terpolymer component (a) herein results in increased dispersibility of the composition(s) in aqueous solutions due to the characteristics of the silicone copolymer and/or terpolymer (a) in contrast to 100 weight percent silicone “oil” systems that contain at least one metal oxide-filled non-polyether moiety-containing silicone fluid.

Numerous other auxiliary ingredients can be included to the gas processing composition described herein. For example, it is common practice to include one or more components selected from biocides, diluents, thickeners, pH adjusters, buffers, corrosion inhibitors or oxidation inhibitors.

The compositions and methods provided herein can be used in gas sweetening processes, specifically in the applications of detergents, polymer processing, well treating, and waste streams for the reduction and suppression of foam in said applications.

Examples have been set forth below for the purpose of illustration. The scope of the invention is not to be in any way limited by the examples set forth herein.

### EXAMPLES

A modified alkanolamine test solution (modified aqueous MDEA solution as described above) was made by the addition of 0.1 weight percent of sodium dodecyl sulphate to 300 milliliters (mL) of an aqueous aMDEA® solution available from BASF, in a 1000 mL graduated cylinder, wherein said weight percent of sodium dodecyl sulphate is based on total weight percent of modified aqueous MDEA test solution. The modified aqueous MDEA solution alone was sparged at 4 liters per minute (L/min) of air through a glass rod and frit placed in the graduated cylinder, which frit was connected to a flow meter and no stable foam could be generated with the alkanolamine solution alone (only the aMDEA® available from BASF). To provide foam which could be treated by the antifoams herein, the sodium dodecyl sulphate was added as described herein, in order to modify the aMDEA® available from BASF into a foamable modified aqueous MDEA solution which was used for all the testing herein. Testing of various antifoam compositions indicated in the Tables was then conducted at room temperature and at 50 degrees Celsius, as more specifically indicated below in each of the examples and as described above. This setup for the testing of the various compositions was a 1000 mL graduated cylinder which was equipped with a glass rod and frit, which rod and frit were connected to a gas flowmeter. The various silicone polymers or copolymers (antifoams) to be tested were each then added and dispersed into separate but equivalent 300 mL the modified aqueous MDEA solutions present in a 1000 mL clean measuring cylinder by means of micropipette before starting the antifoam tests. The dispersed individual antifoams in the separate but equivalent modified aqueous MDEA solutions were then added to said equipped cylinder set up. The combination of antifoam and modified alkanolamine solution was then sparged through the frit of the set up at 4 Litres/min of air. During sparging the foam volume was noted against the sparging time as quantified and tabulated in Tables 1-4.

The various silicone copolymers used in FIGS. 1-4 are identified as indicated herein below, in Table A. All molecular weights are theoretically calculated based upon their nominal structure unless stated otherwise.

EO is understood to mean ethylene oxide moiety and PO is understood to mean propylene oxide moiety. Me is methyl. Bu is butyl.

P-2000(E) is a polypropylene glycol with an average molecular weight of 2,000 available from Dow Chemical Company. It will be understood herein that when polypropylene glycol is used herein, that it is simply physically blended with the silicone copolymer and/or terpolymer and any metal-oxide that may be present in the silicone copolymer and/or terpolymer prior to use. Sag® 7133 is a “silica-filled” polydimethylsiloxane antifoam emulsion currently sold into gas sweetening applications available from GE Advanced Materials. It will be understood herein that the sparging of P-2000(E) alone and Sag® 7133 alone are intended to be comparative and/or control examples, where all of these comparative examples are dosed in 300 mL of the equivalent modified aqueous MDEA solution; and no antifoam is also intended to indicate a control and/or comparative example where only 300 mL of the modified aqueous MDEA solution is sparged.

Aerosil® “R812” and Sipernat® “D-10” are fumed and precipatated silica powders respectively manufactured and available from the Degussa Corporation. TP-317 is a silicone copolymer available from GE Advanced Materials (GEAM). SilSoft® Shine is a Methyl Eugenol, polyether silicone terpolymer available from GEAM. TP-325 is eugenol, polyether silicone terpolymer available from GEAM. Magnasoft® SRS is a linear (AB)nA aminopolyether epoxy silicone terpolymer in DPG available from GEAM. NuWet® 625 is an epoxy modified silicone polyether terpolymer available from GEAM. Y-14182 is an alcoholether, polyether silicone terpolymer available from GEAM. L-9000/100 is a silanol endblocked silicone fluid with a viscosity of 100 centistokes available from GEAM and is used as a comparative example. Sag®7133 is a “silica filled” PDMS antifoam emulsion currently sold into gas sweetening applications available from GEAM and is used as a comparative example of a metal-oxide filled non-polyether moiety containing silicone fluid.

TABLE A

| Name of | | Weight |
|---|---|---|
| Silicone | | Ratio of Alkylene Oxide Moieties |
| Copolymer | Molecular Weight | And If Capped and With What Group |
| L-7220 | 17,000 | EO/PO = 20/80, Uncapped |
| L-7001 E | 13,000 | EO/PO = 20/80, Me-capped |
| L-7500 | 3,000 | EO/PO = 0/100, Bu-capped |
| L-7510 | 13,000 | EO/PO = 0/100, Uncapped |
| Y-14852 | 7,600 | EO/PO = 100/0, Uncapped |
| Y-14959 | 50,000 | EO/PO = 35/65, Me-capped |
| Y-14957 | 9,000 | EO/PO = 100/0, Me-capped |
| Y-14977 | 24,000 | EO/PO = 30/70, Me-capped |
| L-7230 | 29,000 | EO/PO = 40/60, Uncapped |
| L-7210 | 13,000 | EO/PO = 20/80, Uncapped |

All of the tested materials in Table A are all available from GE Advanced Materials, (GEAM).

### Example 1

The various silicone copolymers indicated in Table 1 and identified above were each separately dosed at 17 ppm and dispersed into 300 mL of modified aqueous MDEA solution at room temperature. Each antifoam composition was then sparged as indicated above. Table 1 illustrates the results of the sparging of 17 ppm of each particular silicone copolymer in 300 mL of modified aqueous MDEA solution at room temperature against no antifoam (comparative example) in an equivalent 300 mL of modified aqueous MDEA solution at room temperature.

TABLE 1

| | | Foam volume | |
|---|---|---|---|
| | | after 600 seconds or | |
| | Foam Height at 0 | sparging time to reach a Foam | |
| Product | seconds/mL | Height of 1000 mL | |
| Control (no antifoam) | 300 | 223 | secs |
| Comparative | | | |
| Example | | | |
| L-7220 | 300 | 500 | mL |
| L-7210 | 300 | 460 | mL |
| L-9000/100 | 300 | 510 | mL |
| Comparative | | | |
| Example | | | |
| L-7001E | 300 | 510 | mL |
| L-7230 | 300 | 500 | mL |
| Y-14959 | 300 | 430 | mL |

### Example 2

The various silicone copolymers and terpolymers indicated in Table 2 and identified above were each separately dosed at 17 ppm and dispersed into 300 mL of modified aqueous MDEA solution at 50 degrees Celsius. Each antifoam composition was then sparged as indicated above. Table 2 illustrates the results of the sparging of 17 ppm of each particular silicone copolymer or terpolymer in 300 mL of modified aqueous MDEA solution at 50 degrees Celsius against, no antifoam (comparative example) in an equivalent 300 mL of modified aqueous MDEA solution at 50 degrees Celsius, 17 ppm of DPG (comparative example) in an equivalent 300 mL of modified aqueous MDEA solution at 50 degrees Celsius, 17 ppm of 2-ethylhexanol (comparative example) in an equivalent 300 mL of modified aqueous MDEA solution at 50 degrees Celsius, and 17 ppm of silica-filled polydimethylsiloxane antifoam emulsion (comparative example of metal oxide-filled non-polyether moiety-containing silicone fluid) in an equivalent 300 mL of modified aqueous MDEA solution at 50 degrees Celsius.

TABLE 2

| | | Foam volume after 600 seconds | |
|---|---|---|---|
| | Foam Height at | or sparging time to reach a Foam | |
| Product | 0 seconds/mL | Height of 1000 mL | |
| Control (no antifoam) | 300 | 164 | secs |
| Comparative Example | | | |
| L-7500 | 300 | 710 | mL |
| L-7510 | 300 | 600 | mL |
| Y-14977 | 300 | 480 | mL |
| Y-14957 | 300 | 480 | mL |
| L-7210 | 300 | 430 | mL |
| Y-14852 | 300 | 440 | mL |
| Y-14959 | 300 | 410 | mL |
| L-7230 | 300 | 390 | mL |
| SilSoft ® Shine | 300 | 640 | mL |
| TP-317 | 300 | 530 | mL |
| TP-325 | 300 | 520 | mL |
| Y-14182 | 300 | 480 | mL |
| Magnasoft ® SRS | 300 | 410 | mL |
| NuWet ® 625 | 300 | 390 | mL |
| Dipropylene Glycol | 300 | 640 | mL |
| Comparative Example | | | |
| 2-Ethyl Hexanol | 300 | 520 | mL |
| Comparative Example | | | |
| Sag ® 7133 | 300 | 450 | mL |
| Comparative Example | | | |

### Example 3

The various silicone copolymers indicated in Table 3 and identified above were dosed at 17 ppm and dispersed in 300 mL of modified aqueous MDEA solution at room temperature. Each antifoam composition was then sparged as indicated above. Table 3 illustrates the results of the sparging of 17 ppm of each particular silicone copolymer in 300 mL of modified aqueous MDEA solution at room temperature against, no antifoam (comparative example) in 300 mL of modified aqueous MDEA solution at room temperature, and 17 ppm of silica-filled polydimethylsiloxane antifoam emulsion (comparative example of metal oxide-filled non-polyether moiety-containing silicone fluid) in 300 mL of modified aqueous MDEA solution at room temperature.

TABLE 3

| | | Foam volume after 600 | |
|---|---|---|---|
| | | seconds or sparging time to | |
| | Foam Height at 0 | reach a Foam Height of | |
| Product | seconds/mL | 1000 mL | |
| Control (no antifoam) | 300 | 178 | secs |
| Comparative Example | | | |
| Y-14977 | 300 | 680 | mL |
| Y-14957 | 300 | 580 | mL |
| Y-14959 | 300 | 420 | mL |
| Sag ® 7133 | 300 | 550 | mL |
| Comparative Example | | | |

### Example 4

A silicone copolymer as indicated in Table 4 and identified above was dosed at 17 ppm into 300 mL of modified aqueous MDEA solution at room temperature. The antifoam composition was then sparged as indicated above. Table 4 illustrates the results of the sparging of the particular silicone copolymer identified therein, in 300 mL of modified aqueous MDEA solution at room temperature against, no antifoam (comparative example) in 300 mL of the equivalent modified aqueous MDEA solution at room temperature, 17 ppm of polypropylene glycol (comparative example) with a number molecular weight of 2000 in 300 mL of the equivalent modified aqueous MDEA solution at room temperature, and 17 ppm of the silicone copolymer in various mixtures and blends with fumed or precipated silica, and/or polypropylene glycol with a number molecular weight of 2000 in equivalent 300 mL modified aqueous MDEA solutions at room temperature, as described in Table 4.

TABLE 4

| | | Foam volume after 600 | |
|---|---|---|---|
| | | seconds or sparging time | |
| | Foam Height at | to reach a Foam | |
| Product | 0 seconds/(mL) | Height of 1000 mL | |
| Control (no antifoam) | 300 | 222 | secs |
| Comparative Example | | | |
| Polypropylene Glycol (P- | 300 | 415 | secs |
| 2000(E)) | | | |
| Comparative Example | | | |
| Y-14959 & 3 wt % Aerosil | 300 | 440 | mL |
| R812 | | | |
| Y-14959 & 3 wt % Sipernat | 300 | 430 | mL |
| D-10 | | | |
| Y-14959 & 3 wt % Aerosil | 300 | 440 | mL |
| R812 diluted to 50 wt % with | | | |
| P-2000(E) | | | |
| Y-14959 & 3 wt % Sipernat | 300 | 420 | mL |
| D-10 diluted to 50 wt % with | | | |
| P-2000(E) | | | |
| Y-14959 diluted to 50 wt % | 300 | 410 | mL |
| with P-2000(E) | | | |

### Example 5

Various silicone copolymers and terpolymers were dosed at 17 ppm into 300 mL of modified aqueous MDEA solution at 50° C. The antifoam compositions were then sparged as indicated above. Table 5 illustrates the results of the sparging of the particular silicone co and/or terpolymer identified therein, in 300 mL of modified aqueous MDEA solution at room temperature against, no antifoam (comparative example) in 300 mL of the equivalent modified aqueous MDEA solution at room temperature. The results are given as foam volume of the particular antifoam compositions in a 1000 ml graduated cylinder which are sparged as indicated above and are reported at zero seconds and at 600 seconds at intervals of 1 day, 1 week and two weeks. This is a test of the maintenance of the antifoaming ability as it is described herein. The prolonged antifoam activity of silicone co/terpolymers in Table 5 has been shown by retesting the same modified aqueous alkanolamine solutions containing the silicone copolymer or terpolymer (a) detailed in Table 5, after 1 day, 1 week and 2 weeks respectively. The solution was subjected to a minimum of 600 secs sparging on day 1 and antifoaming activity was noted in volume of foam after the sparging. After a further week of storage, the same solution was subjected to the same experimental conditions and similar sparging. Similarly, after a two week interval from the original mixing of the solution, sparging under similar experimental conditions was carried.

TABLE 5

| | After 1 Day | | After 1 week | | After 2 weeks | |
|---|---|---|---|---|---|---|
| | | Foam | | Foam | | Foam |
| | Foam | volume | Foam | volume | Foam | volume |
| | Height at 0 | after 600 | Height at 0 | after 600 | Height at 0 | after 600 |
| | seconds/ | seconds/ | seconds/ | seconds/ | seconds/ | seconds/ |
| Product | (mL) | (mL) | (mL) | (mL) | (mL) | (mL) |
| Control (no | 300 | >1000 | 300 | 780 | 300 | 640 |
| Antifoam) | | | | | | |
| Comparative | | | | | | |
| Example | | | | | | |
| Y-14182 | 300 | 480 | 300 | 380 | 300 | 390 |
| Y-14852 | 300 | 430 | 300 | 390 | 300 | 390 |
| Y-14959 | 300 | 410 | 300 | 380 | 300 | 390 |
| L-7230 | 300 | 390 | 300 | 370 | 300 | 380 |
| NuWet ® 625 | 300 | 390 | 300 | 360 | 300 | 360 |

Thus, whereas there have been described what are presently believed to be the preferred embodiments of the present invention, those skilled in the art will realize that other and further embodiments can be made without departing from the spirit of the invention, and it is intended to include all such further modifications and changes as come within the true scope of the claims set forth herein.

What is claimed is:

1. A composition which comprises:
(a) a silicone copolymer and/or terpolymer component containing a polyether moiety; and,
(b) a water-soluble and/or water dispersible gas-processing component; said composition being substantially free of metal oxide-filled non-polyether moiety-containing silicone fluid.

2. The composition of claim 1, wherein silicone copolymer and/or terpolymer component (a) is a pendant and/or linear structure.

3. The composition of claim 1, wherein silicone copolymer and/or terpolymer component (a) is hydrolyzable and/or non-hydrolyzable.

4. The composition of claim 1 wherein silicone copolymer and/or terpolymer component (a) comprises at least one moiety selected from the group consisting of ethylene oxide, propylene oxide and butylene oxide.

5. The composition of claim 1, wherein silicone copolymer and/or terpolymer component (a) comprises at least one polydimethylsiloxane-polyoxyalkylene co-polymer and/or terpolymer.

6. The composition of claim 5, wherein the polydimethylsiloxane-polyoxyalkylene co-polymer and/or terpolymer and has a polydimethylsiloxane portion bound to a polyoxyalkylene portion wherein the polyoxyalkylene portion is at least one selected from the group consisting of polyoxyethylene, polyoxypropylene and polyoxybutylene.

7. The composition of claim 1, wherein at least one silicone copolymer and/or terpolymer of silicone copolymer and/or terpolymer component (a) is substantially filled with metal oxide.

8. The composition of claim 7, wherein silicone copolymer and/or terpolymer that is substantially filled with metal oxide is substantially filled with particulate silica.

9. The composition of claim 8, wherein the particulate silica is selected from the group consisting of fumed silica, precipitated silica, and combinations thereof.

10. The composition of claim 1, wherein silicone copolymer and/or terpolymer component (a) has a molecular weight of from about 1,500 to about 100,000.

11. The composition of claim 1, wherein silicone pendant copolymer and/or terpolymer component (a) has a molecular weight of from about 7,000 to about 50,000 and contains an ethylene oxide to propylene oxide weight ratio of from about 1:4 to about 4:4.

12. The composition of claim 1, wherein the water-soluble and/or water-dispersible gas-processing component (b) is at least one gas-treating agent.

13. The composition of claim 1, wherein the water-soluble and/or water-dispersible gas-processing component (b) is at least one gas-treating agent selected from the group consisting of alkanolamine and alkylamine.

14. The composition of claim 1, wherein the water-soluble and/or water-dispersible gas-processing component (b) is at least one gas-treating agent wherein the gas-treating agent is an alkanolamine selected from the group consisting of monoethanolamine, diethanolamine, diisopropanolamine, triethanolamine, N-methyldiethanolamine, monomethylethanolamine, (2-(2-aminoethoxy)ethanol, and combinations thereof.

15. The composition of claim 1, wherein the water-soluble and/or water-dispersible gas-processing component (b) is at least one gas-treating agent wherein the gas-treating agent is an alkylamine selected from the group consisting of monoalkylamine, dialkylamine, and trialkylamine.

16. The composition of claim 1, which further comprises polypropylene glycol.

17. The composition of claim 1, which further comprises water.

18. The composition of claim 16, wherein the polypropylene glycol and silicone copolymer and/or terpolymer component (a) are in a polypropylene glycol to silicone copolymer and/or terpolymer component (a) weight ratio range of approximately 1:20 to 200:1.

19. The composition of claim 1, wherein the composition is an antifoaming gas-processing composition that retains its antifoaming ability for at least a period of 1 week.

20. The composition of claim 1, wherein the composition is an antifoaming gas-processing composition that exhibits less fouling than a gas-processing composition that contains metal oxide-filled non-polyether moeity-containing silicone fluid.

21. A method for processing a gas comprising treating the gas with a composition which comprises:
(a) a silicone copolymer and/or terpolymer component containing a polyether moeity; and,
(b) a water-soluble and/or water dispersible gas-processing component; said composition being substantially free of metal oxide-filled non-polyether moiety-containing silicone fluid.

22. The method of claim 21, wherein the gas is at least substantially methane.

23. The method of claim 21, wherein the gas-processing component (b) is regenerated by a gas desorption process.

24. The method of claim 21, wherein treating the gas comprises lowering or substantially removing an amount of at least one base-reactive impurity wherein the impurity is at least one selected from the group consisting of carbon dioxide and sulfhydryl-containing compounds.

25. The method of claim 21, wherein the gas-processing component (b) is a gas-treating agent that is reclaimed by a gas desorption process.

26. The method of claim 21, wherein the gas-processing component (b) is a gas sweetening amine that is reclaimed by a gas desorption process.

27. The method of claim 21, wherein the composition is an antifoaming gas-processing composition that retains its antifoaming ability for at least a period of 1 week.

28. The method of claim 21, wherein the composition is an antifoaming gas-processing composition that exhibits less fouling than a gas-processing composition that contains metal oxide-filled non-polyether moiety-containing silicone fluid.
